(19) United States
(12) Patent Application Publication
(10) Pub. No.: US 2024/0232277 A9
(43) Pub. Date: Jul. 11, 2024

(54) A SYSTEM FOR ACCESSING A WEB PAGE

(71) Applicant: TEKKPRO LIMITED, Harrow (GB)

(72) Inventors: Colin Keith TUNNICLIFFE, Staines (GB); Daniel Robert COX, Ashford (GB)

(73) Assignee: TEKKPRO LIMITED, Harrow (GB)

(21) Appl. No.: 18/276,779

(22) PCT Filed: Jan. 21, 2022
(86) PCT No.: PCT/GB2022/050170

§ 371 Date: Aug. 10, 2023

(30) Foreign Application Priority Data
Feb. 12, 2021 (GB) 2101968.2

(51) Int. Cl. G06F 16/955; G06F 16/432; G06F 16/583; G06Q 30/0601; G06V 20/40

(52) U.S. Cl. CPC G06F 16/955; G06F 16/434; G06F 16/583; G06Q 30/0641; G06V 20/41

(57) ABSTRACT

A system for pointing to a web page including a screen for viewing pre-recorded scenes, a number of items shown in each scene, a mobile camera device, a processor, a connection to internet and access to computing devices including a machine learning cloud and at least one database including a plurality of scene identifiers each associated with item data, including steps of a user capturing at least one image of the screen, processing the at least one image to obtain at least one prepared image, sending said at least one prepared image to the machine learning cloud, executing a comparison algorithm to compare said at least one prepared image, the machine learning cloud identifying said scene with a degree of certainty, inserting the respective scene identifier, sending at least a portion of said item data to said user, with a link to said web page for each item.

The present invention relates to a system for accessing a web page, a mobile camera device and a method for obtaining information relating to a live streamed event. The present invention also relates to a system for facilitating putting a consumer into contact with a vendor.

Presently, a user has a number of options to find a website or particular page of a website.

A website is assigned a web address, known as a URL. The user may type the web address into an address box of a web browser of a computer system, smart phone, tablet or the like to display the web page on a screen.

Alternatively, the user may use a search engine to find the website. The user thinks of a “query”, a few words which the user believes will find the website. The user then types the query into a dialogue box in a user interface landing page of a search engine, displayed on a Visual Display Unit of a computer system, smart phone, tablet or the like. The search engine executes algorithms and may interrogate various databases, web pages, web page metadata and use Natural Language Processing to come up with synonyms and the like to add to the query to draw up a list of links. The results usually appear in a fraction of a second. Each link is provided with a brief description or excerpt relevant to the destination of the link. Each link is provided with a unique Uniform Resource Locator (URL). The user has the final decision by clicking on the link which the user wants to follow, which inserts the URL behind the link into the address box of the web browser, sending the user to the landing page of a particular website or a specific page of the website of interest. The URL may be static, having static content or dynamic, having content which is updated regularly. Instead of typing a query into a dialogue box, a user may use a “smart speaker”, which has an inbuilt microphone and uses voice recognition in order to convert sounds into computer readable text, such as ASCII code which is then electronically inserted into a query box of a search engine. The same list of results may be read out by and through a speaker in the smart speaker or display the list on a visual display unit or the search engine may take the user directly to the website at the top of the list.

Content such as film, music videos, serialised dramas, comedy shows and the like are usually pre-recorded and made available for viewing at a later date. Users may view such content via broadcast: terrestrial television sets receiving broadcast radio frequency signals; and television sets receiving microwave signals, typically from satellites. Such content may be stored on DVDs for viewing using a DVD player or may be downloaded from the internet as a compressed electronic file (such as .MP4, .MOV, .WMV etc.) which can be viewed at anytime. More recently, such content is streamed over the internet to smart televisions, smart phones, tablets, desktops and laptops on-demand or may be streamed at set times.

Viewers frequently see items within such content which they would like to own themselves. It is often difficult to find such items. It is known such item manufacturers, importers and distributors set out on an expensive advertising campaigns upon launch of the content in order to make best use of product placements in films. However, this only works in a very limited number of specific product placements and is very expensive. The items are often available to purchase, but very difficult to find.

Very recently, it has become known for news networks to display a QR code in an overlay over the live broadcast. A user may use a camera on a smart phone or tablet and point the camera at the screen so that the QR code is the field of view and field of focus of the camera. The smart device automatically detects the presence of the QR code, reads the QR code and automatically displays a message on the smart phone or tablet offering the user a link to a website associated with the QR code.

The inventors have observed that this requires an active step to be provided by the broadcast network to provide a QR code on an overlay so it can be viewed by the user along with the broadcast content.

There are many billions of web pages accessible on the internet and thus there are many technical problems associated with finding a page which will be of interest to the user. In time critical environments, saving seconds to accomplish this is of utmost importance. Linking a product placement with a customer may be regarded as time critical.

In accordance with the present invention, there is provided a system for pointing to a web page, the system comprising a screen for viewing pre-recorded content, the pre-recorded content comprising a plurality of scenes, a number of items shown in each scene, a mobile camera device having a camera, at least one processor, a connection to internet and access to a multiplicity of computing devices in the internet comprising a machine learning cloud and at least one database comprising a plurality of scene identifiers each scene identifier associated with item data describing the items shown in that scene, the system comprising the steps of a user capturing at least one image of the screen displaying the pre-recorded content with said mobile camera device, processing the at least one image to obtain at least one prepared image, sending said at least one prepared image to a machine learning cloud, executing a comparison algorithm to compare said at least one prepared image with a data bank of stock images obtained from a substantial number of stock scenes of pre-recorded stock content, each stock scene assigned with a scene identifier, the machine learning cloud identifying said scene with a degree of certainty, inserting the respective scene identifier in the database to obtain said item data appearing in said scene, sending at least a portion of said item data or data relating thereto to said user, with a link to said web page for each item.

Optionally, the web page facilitates purchase of the item and may be a web page on a vendor website or a specific item page or list of similar and complementary items of a shopping search engine, such as Kelkoo, Amazon, Ebay etc.

Optionally, the item data is a list of items appearing in the scene. Optionally, the item data comprises a written description of the item, preferably with brand, model, colour and style information and preferably with a Stock Keeping Unit number or a Universal Product Code (UPC number). A SKU number may be used by a single vendor. A UPC may be used by any vendor and can thus be used to search through a number of vendors inventories for the user to obtain a satisfactory price and delivery.

The database may comprise item data about items which are commercially available and some which are not. A filter may be applied on the database to only make available item data of items which are commercially available.

Optionally, the scene identifier also comprises a pre-recorded stock content identifier. Optionally, the pre-recorded stock content comprises at least one of: films; music videos; serialised dramas; comedy shows; factual programs. The pre-recorded stock content identifier may include the title and may also include other details, such as the production company name, director, producer, main actors, genre etc. The pre-recorded stock content identifier may be an identifying number.

The present invention also provides a system for pointing to a web page, the system comprising a screen for viewing pre-recorded content, the pre-recorded content showing a number of items, a mobile camera device having a camera, at least one processor, a connection to internet and access to a multiplicity of computing devices in the internet comprising a machine learning cloud and at least one database comprising a content identifier associated with item data describing the items shown in the pre-recorded content, the system comprising the steps of a user capturing at least one image of the screen displaying the pre-recorded content with said mobile camera device, processing the at least one image to obtain at least one prepared image, sending said at least one prepared image to a machine learning cloud, executing a comparison algorithm to compare said at least one prepared image with a data bank of stock images obtained from a substantial number of pre-recorded stock content, each pre-recorded stock content assigned with an identifier, the machine learning cloud identifying said pre-recorded content with a degree of certainty, inserting the respective identifier into the database to obtain the item data, sending said at least a portion of the item data to said user with a link for each item to said web page.

Optionally, at least one of the pre-recorded stock content comprises a plurality of scenes, each scene provided with a scene identifier, the machine learning cloud identifying said scene with a degree of certainty, inserting the respective scene identifier in said database to obtain a list of said items, optionally sending said list of items to said user optionally with a link for each item to said web page.

Optionally, the system has access to a multiplicity of databases, one database for each pre-recorded content.

Optionally, the mobile camera device is one of: a smart phone; a tablet; a smart watch; and smart spectacles. Smart phones generally comprise a screen, a processor and circuitry for providing both cellular data and Wi-Fi data communication with the internet. Optionally, the website is accessed through an app or widget, which may launch a program having a web browser embedded therein.

Optionally, the list of items includes a brief description of each item. Optionally, the brief description is inserted into a search engine (optionally, a vendor search engine) to find the link to the web page.

Optionally, each item is assigned an SKU number which may be unique to each item. This is useful if the SKU correlates to a vendor as well as the film production company which may have initially set the SKU numbers for their logistics and internal stock control.

Optionally, the screen forms part of a smart television, laptop, desktop, tablet or other smart phone.

Optionally, a characteristic of the screen displaying the pre-recorded content is an oblong: four corners with two pairs of parallel sides when viewed from directly in front, but appears as another type of quadrilateral when viewed from an angle. The step of processing the at least one image to obtain at least one prepared image comprises taking these characteristics to detect and recognise the screen and thus define the bounds of the image to be captured and sent on to be analysed. If the user “zoomed in” such that the screen appears larger on his display, it would still identify the same position in panoramic space as if he had drawn the quadrilateral while zoomed out. An affine transformation may be employed in detecting the bounds of the screen to define the area of the image displayed thereon. This defined area is captured in the image and only the part of the entire image within the quadrilateral is used in the machine learning comparison step. The “noise” outside of the area is then deleted or marked as such from the image as part of the processing and is not used in the step of comparison in the machine learning cloud. Alternatively or additionally, a range imaging sensor is used in the mobile camera device, such as a LiDAR (Light Detection And Ranging), which emits beams of laser light and measures the time it takes for the light to return to the sensor to be able to form a three dimensional, Euclidean data map of points in space. The data from the LiDAR sensor is used to identify the shape of any frame of the screen. The area external to the frame of the screen is further away of the screen. Noise outside of the bounds of the screen is then deleted from the image as part of the processing to produce the processed image.

Optionally, the mobile camera device comprises a flash. Optionally, the system comprises software to disable the flash.

Unwanted reflections on the screen may appear in the captured image. A light, such as the sun, may be shining on screen when the image is captured. Optionally, the image is processed to change the colour contrast and hue. Optionally, the colour contrast is increased. Optionally, the image is processed in an attempt to remove glare.

Optionally, the list of items is sent to the mobile camera device. Optionally, within the application program (app) and/or using a browser app. Optionally, the list of items is sent to an email address of the user.

Optionally, the mobile camera device comprises a viewing screen, the step of capturing the image comprising a user interface shown on the viewing screen, the user interface comprising a viewing template and a real-time view of the field of view of the camera, optionally the user is prompted to line up the frame of the screen with the template. Optionally, the template comprises four corner guides, a complete rectangle and/or at least one cross.

Optionally, the at least one image is a plurality of images taken as a “burst”. A burst may be a plurality of still images, such as between two and twenty still images, taken within a set time, such as within one second. A frame rate of between 10 and 20 frames per second may be used to capture a burst image. Each still image of the plurality of images is prepared as described herein with reference to a single image. The plurality of images are then sent to the machine learning cloud. This potentially improves degree of certainty in the comparison between the plurality of images and

The present invention may be applicable to films, serialised dramas, comedy shows, music videos or any similar content comprising props and wardrobe functions or the like.

The present invention also provides a system for pointing to a web page, the system comprising a smart device comprising a screen for viewing pre-recorded content, the pre-recorded content comprising a plurality of scenes, a number of items shown in each scene, at least one processor, a connection to internet and access to a multiplicity of computing devices in the internet comprising a machine learning cloud and at least one database comprising a plurality of scene identifiers each scene identifier associated with item data describing the items shown in that scene, the smart device comprising software to take a screen shot, the system comprising the steps of a user capturing at least one image of the screen displaying the pre-recorded content with said screen shot, processing the at least one image to obtain at least one prepared image, sending said at least one prepared image to the machine learning cloud, executing a comparison algorithm to compare said at least one prepared image with a data bank of stock images obtained from a substantial number of stock scenes of pre-recorded stock content, each stock scene assigned with a scene identifier, the machine learning cloud identifying said scene with a degree of certainty, inserting the respective scene identifier in the database to obtain said item data appearing in said scene, sending at least a portion of said item data or data relating thereto to said user, with a link to said web page for each item. Such a system is useful in the case of the content, such as a film or music video, is viewed on a smart device, typically and iPad or other tablet. The user simply opens the Vuugle app which displays the camera function and is presented with the option of capturing a screen shot of the film content. The screen shot optionally executes an algorithm which actually takes a burst image comprising a plurality of images to be processed and prepared for use in the machine learning cloud comparison step.

Optionally, the smart device is one of: a smart television with screen shot capability; tablet; and smart phone.

Optionally, the screen shot takes an image burst. Optionally, the image burst comprises between two and twenty still images taken over a period of between 0.1 and 1 second.

Optionally, the at least one image is processed to change the colour contrast and optionally to change hue.

Optionally, the comparison algorithm to compare said at least one prepared image with said data bank of stock images obtained from said substantial number of pre-recorded stock content, is trained using stock images obtained from said substantial number of pre-recorded stock using a frame rate of between 5 and 30 frames per second. and optionally between 10 and 20 fps.

For a better understanding of the present invention, reference will now be made, by way of example, to the accompanying drawings, in which:

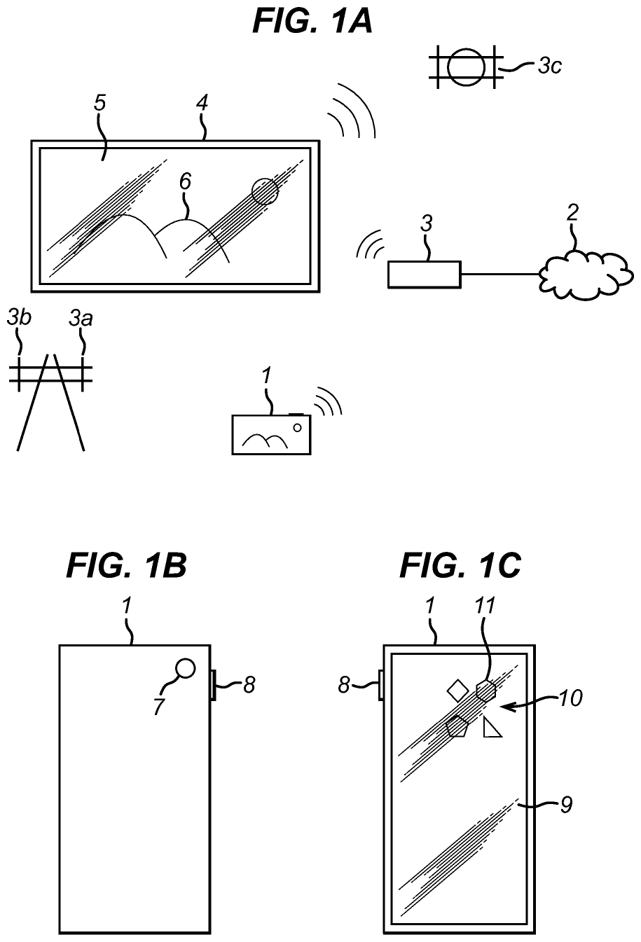

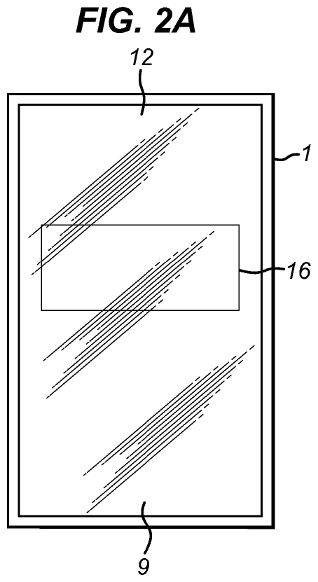

FIG. 1A is a schematic view of a system in accordance with the present invention incorporating a smart phone shown;

FIG. 1B is a schematic view of a rear face of the smart phone shown in FIG. 1A;

FIG. 1C is a schematic view of a front face of the smart phone shown in FIG. 1A, at a first point in time;

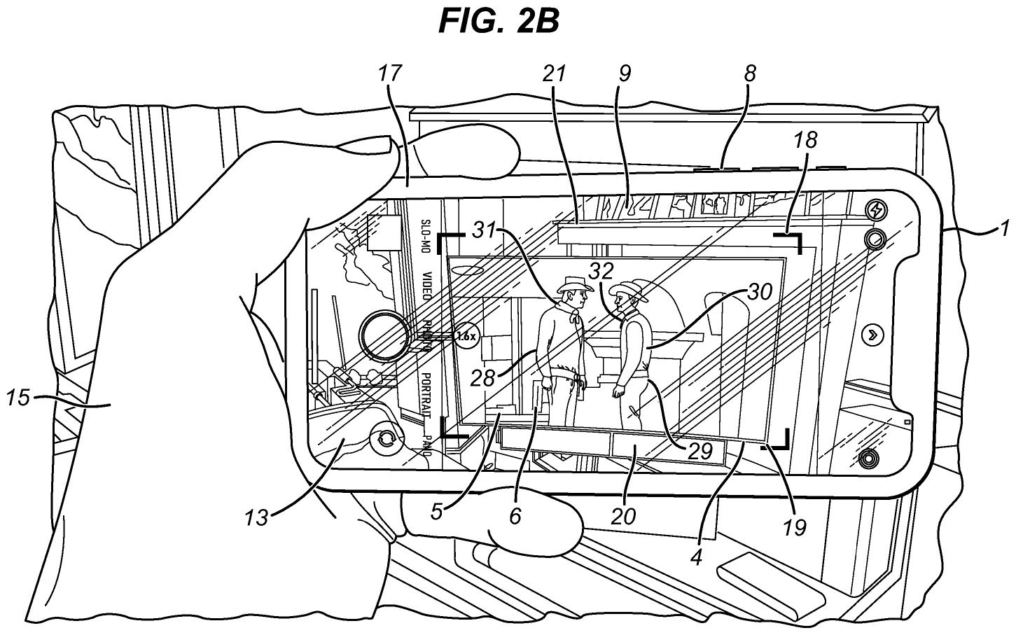

FIG. 2A is a user interface of the application program run on the smart phone in portrait orientation of the system shown in FIG. 1A, with a pop up window;

FIG. 2B is the user interface of the application program run on the smart phone in landscape orientation of the system shown in FIG. 1A, at a second point in time;

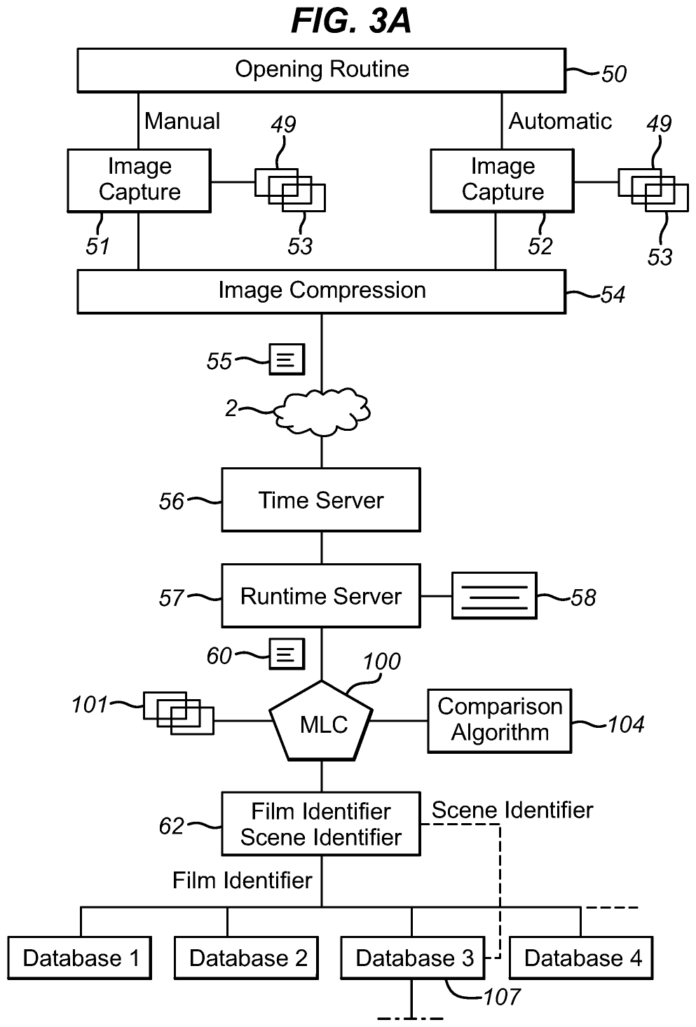

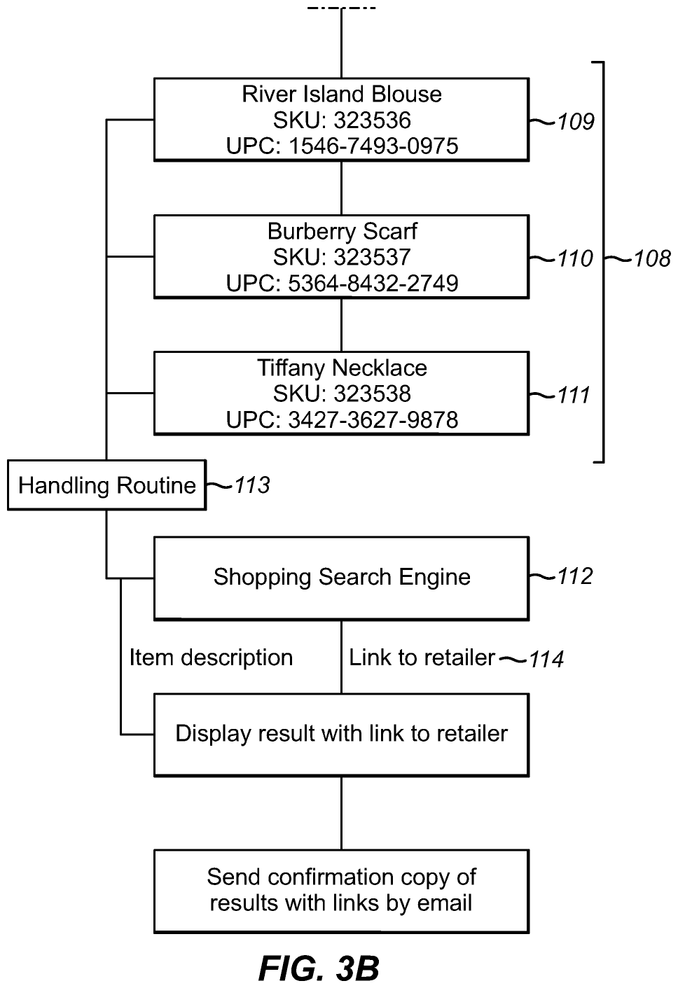

FIGS. 3A and 3B show a flow diagram of the system shown in FIG. 1A;

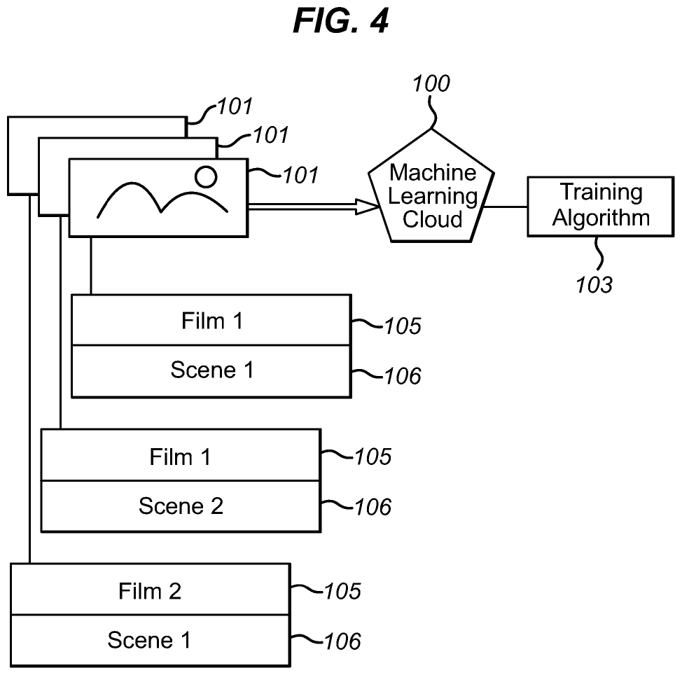

FIG. 4 is a flow diagram showing steps in training the machine learning cloud;

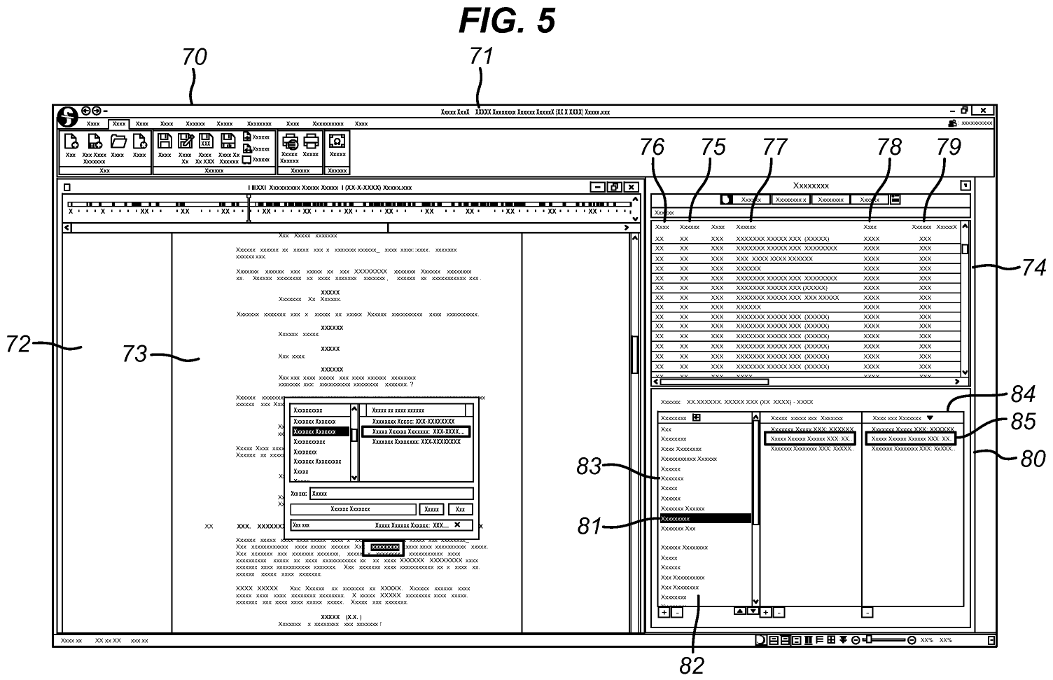

FIG. 5 is a screen shot of a user interface of Database 3;

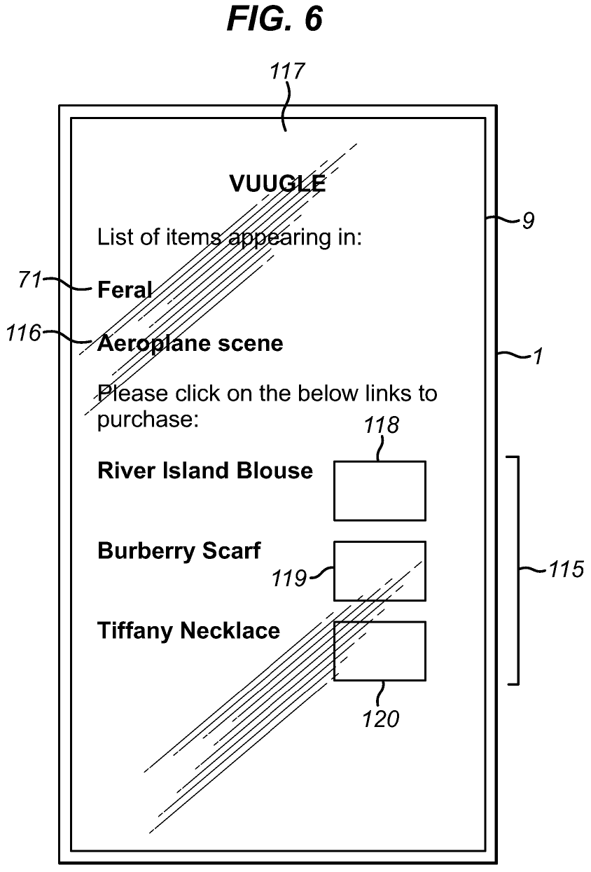

FIG. 6 is a screen view of the smart phone of the system shown in FIG. 1A showing a user interface of the present invention; and

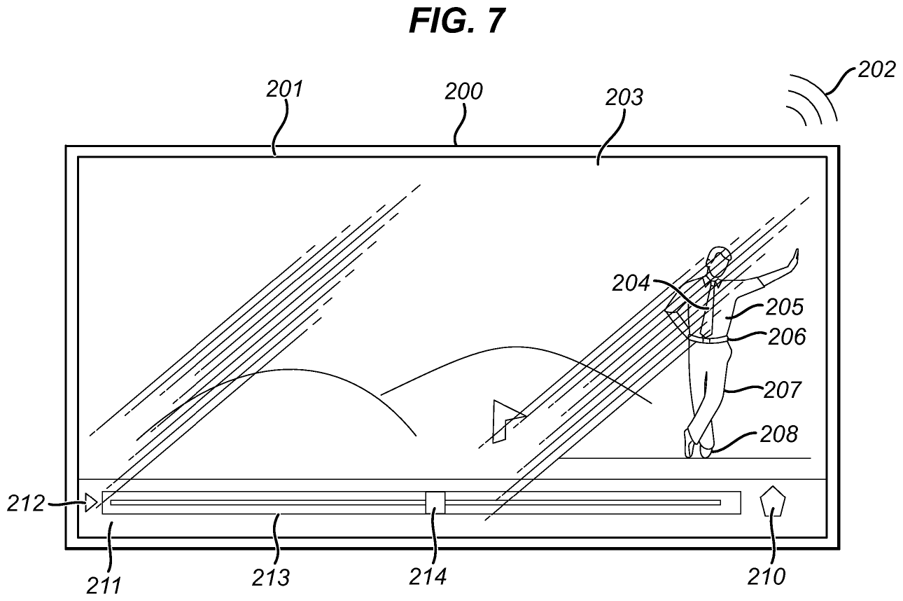

FIG. 7 is a front view of a smart device playing film content, which forms part of a system in accordance with the present invention.

Referring to FIGS. 1A, there is shown a schematic view of a system in accordance with the present invention. The system comprises a smart phone 1, although the smart phone 1 may be any mobile camera device such as a tablet, a smart watch or smart spectacles. The smart phone 1 has access to the internet 2 via Wi-Fi through a home router 3 or over a mobile data network 3a, such as 4G and 5G.

A smart television 4 is also provided with Wi-Fi communication having access to the internet 2 via the router 3 or mobile data network 3a. The smart television has an electronic visual display 5, herein referred to as a screen. The screen 5 may be oblong oriented in landscape and have an aspect ratio of 16:9, 4:3 or 2.4:1 or any other suitable aspect ratio. It should be noted that the smart television 4 may have a screen 5 of any suitable dimensions, most commonly having a diagonal dimension in the order of 20″ (50 cm) to 75″ (190 cm) although may be of larger or smaller dimensions. The smart television 4 may alternatively be a tablet (not shown), typically having a screen of diagonal dimension of 8″ (20 cm) to 12″ (30 cm). The smart television 4 may alternatively be another smart phone (not shown) having a screen diagonal dimension of 8″ (20 cm) to 12″ (30 cm).

The screen 5 displays content such as a film 6 streamed from a streaming service over the internet 2. Such streaming services are Netflix, Rakuten, Apple or the like. As an alternative, the film 6 may be broadcast and received over terrestrial radio frequency bands from a terrestrial mast 3b or received from satellite 3c over microwave frequency bands. As a further alternative, the film 6 may be stored on a local hard drive or in solid state memory or on a DVD and viewed on the screen 5.

The smart phone 1 comprises a camera lens 7 and a button 8 for taking a picture. The smart phone 1 is shown in FIG. 1C having the lens 7 facing the screen 5 of the smart television 4. The screen 5 is oblong and oriented in landscape.

The smart phone 1 has a smart phone screen 9, an internal battery (not shown) and at least one processor and memory storage (not shown). The smart phone screen 9 typically has a diagonal dimension of 4″ (10 cm) to 8″ (20 cm). As shown in FIG. 1C, the screen 9 displays a plurality of icons 10 which are either executable application programs or links to executable programs and/or user interface. Such icons 10 may be “apps” or “widgets”.

There is displayed a “VUUGLE” icon 11 which is a link to execute an application program providing a user interface and eventual communication with an online vendor service. Selecting the icon 11 executes an opening computer program 50 having: an opening subroutine which opens a page 12, if the smart phone is held in a portrait orientation (FIG. 2A); and a camera opening subroutine which opens view finder user interface 13, if the smart phone 1 is held in a landscape orientation. The camera opening subroutine 50 comprises code to obtain orientation information from the smart phone 1. The smart phone 1 has a geomagnetic field sensor (not shown) and preferably at least one accelerometer (not shown) to detect orientation of the smart phone. The smart phone 1 is provided with software to interpret information obtained from the geomagnetic field sensor or gyroscope (not shown) and optionally at least one accelerometer (not shown) to glean the orientation of the smart phone 1 and provide an output comprising at least the two positions: “PORTRAIT”, wherein the camera is currently in portrait orientation and “LANDSCAPE” wherein the camera is currently in a landscape orientation. The camera opening subroutine obtains this data via an interface routine. If the data indicates the smart phone 1 is held in a portrait orientation, a dialogue box 16 opens automatically requesting the user to change the orientation of the smart phone 1 to landscape, as shown in FIG. 4. Once the smart phone 1 is in landscape orientation, a view finder user interface 13 appears on the screen and the user 15 is prompted to take a picture of the film 6 shown on the screen 5 of the smart television 4. The camera opening subroutine optionally places the camera in a burst mode so that an image burst 53 comprising a plurality of still images are captured in a short space of time.

The opening sub routine for constructing the user interface and user interface components is optionally written in Java Script optionally using REACT.JS 55 and optionally using a distributed version-control system 56 for tracking changes in source code during software development, such as a GIT host repository. Reconciliation may be used, where a virtual Document Object Model (VDOM) may be used where an ideal or virtual, representation of the user interface is kept in memory and synced with the real DOM by a library such as ReactDOM. The opening computer program may be stored on a time server 51.

The view finder user interface 13 comprises a continuous real-time view through the camera lens 7, taking up substantially the entire smart phone screen 9. A corner alignment template prompts 18 appear in a fixed relation to the screen 9, shown as four corners in FIG. 2B, prompting the user 15 to aim the lens at the smart television 4.

The user 15 may carry out a manual capture step 51 of an image burst 53 of the screen 5 of the film 6 displayed thereon by pressing the smart phones normal camera button 8 once. Optionally or additionally, the opening computer program has an automatic capture sub routine 52 which detects the four corners 19 of the smart television 4. As viewed on the display 9 of the smart phone 1, if the user 15 directs the camera 7 at the smart television 4 in a manner in which the image of the four corners 19 of the smart television 4 are in approximate alignment with respective corner alignment template prompts 18, and the image is in focus, the automatic capture sub routine automatically captures the image or optionally, burst of images, without the need for the user 15 to press the camera button 8 to capture the image. The image burst is optionally captured in colour with a high colour contrast and high hue values for at least the primary colours, which may be set automatically by the camera opening computer program. Optionally, the smart phone 1 comprises a flash, the VUUGLE app comprising a sub routine to instruct the flash to be disabled.

The automatic capture sub routine is optionally written in Java Script and may be kept on the smart phone 1 or the time server 51.

A services computer program 54 comprises a compression sub routine, which activates a compression algorithm held on the smart phone 1 to create a compressed image packet 55. The compression algorithm may be Base64 encoding. The compression sub routine is executed locally on the smart phone 1. The compressed image packet 55 is sent over the internet 2 in the form of binary data to a time server 56 and/or a runtime server 57.

The runtime server 54 is a server on which an executable program is stored, such as the image processing program 58. A suitable runtime server 57 may be a NODE.JS which enables the services computer program to be written in Java Script and stored thereon. NODE.JS provides real-time websites with push capability to run the JavaScript programmes with non-blocking, event-driven I/O paradigm; real-time, two-way connections; uses non-blocking, event-driven I/O data-intensive real-time applications that run across distributed devices. The runtime server 57 may form part of an Amazon Web Server (AWS) service providing Application Program Interfaces. Amazon API Gateway is an AWS (Amazon Web Service) service for creating, publishing, maintaining, monitoring, and securing REST, HTTP, and WebSocket APIs creating APIs that other web services, as well as data stored in the AWS Cloud.

Some or all of the step of processing the image burst 53 are either carried out locally on the smart phone 1 or the compressed image packet 55 is unpacked and some or all of the steps of processing are carried out in the internet 2, optionally on the runtime server 57. Each image 49 of the image burst 53 is processed in several steps to minimise noise. Noise can be caused by image content which is outside bounds of the screen 5, such as soundbar 20 and television cabinet 21 shown in FIG. 2B. A characteristic of the screen 5 displaying the pre-recorded content is an oblong: four corners with two pairs of parallel sides when viewed from directly in front, but may appear as another type of quadrilateral when viewed from an angle. The step of processing each image takes these characteristics to detect and recognise the screen and thus define the bounds of the image to be sent on to create the prepared image file. If the user “zoomed in” such that the screen appears larger on his display and captured the image, it would still identify the same position in panoramic space as if he had drawn the quadrilateral while zoomed out. An affine transformation may be employed in detecting the bounds of the screen to define the area of the image displayed thereon. This defined area is retained in the prepared image file and thus only the part of the entire image within the quadrilateral is used in the machine learning comparison step, details of which are set out below. The “noise”, such as the soundbar 20 and cabinet 21 outside of the quadrilateral area is then deleted or marked as such from the image as part of the processing and is not used in the step of comparison in the machine learning cloud.

The smart phone 1 optionally has a range imaging sensor, such as a LiDAR (Light Detection And Ranging), which emits beams of laser light and measures the time it takes for the light to return to the sensor to be able to form a three dimensional, Euclidean data map of points in space. The data from the LiDAR sensor is used to identify the shape of any frame of the screen 5. The area external to the frame of the screen is further away of the screen 5. Thus the area of the screen is easily defined. Noise outside of the bounds of the screen is then deleted from the image or marked as deleted as part of the processing to produce the prepared image file 60.

Noise can also be produced from glare from direct or indirect artificial or nature lighting on the screen 5. A dirty screen can also cause noise in the image as well as changes in contrast across the screen. Increasing the colour contrast during processing to a high colour contrast is generally desirable as part of the processing to produce the prepared image file 60. Increasing the hue values during processing the image with high hue values is also generally desirable as part of the processing to produce the prepared image file 60.

The content may be sent to and viewed on the smart television 5 as a series of interlaced frames, wherein alternate lines appear subsequently at a frame rate which gives the illusion of a complete picture. Sending an image burst 53 improves the chances of obtaining at least one image 49 which appears without the effects of interlacing. The step of processing the image optionally includes the step of analysing each image for signs of interlacing, and deleting the image if there are signs of interlacing.

The prepared image file 60 is compressed optionally using Base64 compression algorithm in preparation for being sent to a machine learning cloud 100.

REpresentational State Transfer (REST) architecture is used to initiate a connection with the machine learning cloud 100. The prepared image packet 60 is sent to the machine learning cloud 100.

The machine learning cloud 100 has been trained to compare the prepared image in the prepared image file 60 with images obtained from pre-recorded content, such as films.

The Machine Learning Cloud 100 has a training algorithm 103, such as that used in machine learning cloud known as AutoML. The training algorithm 103 is itself trained by following the steps shown in FIG. 4 to produce a usable comparison algorithm 104. The first step is to prepare each film 101. It has been found that taking a still image every 50 to 100 milliseconds of the film played at normal speed yields good results (10 to 20 fps). The colour contrast within the film is exaggerated. The hue of each of the primary colours in the film is also exaggerated. The saturation level may be enhanced.

Each film 101 is labelled with a film identifier 105 and every scene within the film is labelled with a scene identifier 106. The film identifier 106 may comprise bibliographic details of the film, such as title, producer, main actors, studio details, distributor details and details on how they store prop and wardrobe inventory information. The film identifier 106 may alternatively or additionally comprise a universal film number or a number issued by an organisation such as IMDb. The scene identifier 106 may comprise a scene number, a short title and a brief description of the scene.

Each film 101 may be uploaded to the machine learning cloud 100 with a date stamp and a series of commands to ensure the film is dealt with by the machine learning cloud 100 in the correct way, such as defining the bounds of the screen 5 appearing in the image 49 and instructing the comparison only to use the area within the bounds of the screen 5 appearing in the image 49.

A number of sample images and image bursts taken of the screen 5 of a smart television 4 are uploaded and used to train the algorithm. The samples are of many different films and content, as well as samples of the uploaded film. The algorithm learns when given feedback on the results: correct answer or incorrect answer. The algorithm learns as the number of false positive answers decrease. Many thousands of films are uploaded to the machine learning cloud. Once an acceptable degree of accuracy has been achieved, the training algorithm 103 is released into use as a comparison algorithm 104. The comparison algorithm 104 will continue to improve in accuracy as the system is used. The training of the machine learning algorithm 103 may be on going, starting with the useable algorithm 104 and training the algorithm further and then replacing the previous version of the useable algorithm 104 with the newly trained useable version of the algorithm.

Referring back to the diagram shown in FIG. 3, the machine learning cloud 100 applies the comparison algorithm 104 to the prepared image packet 60. Once each image 49 of the burst of images 53 has been analysed by the comparison algorithm 104 in the machine learning cloud 100, the results from each image are compared. If there is an acceptable percentage of images 49 yielding the same result, the useable algorithm 104 outputs identifier file 62 appropriate to the content of the burst of images 53. An acceptable percentage may be above 80% or 90%. The identifier file 62 in this case comprises a film identifier 105 “FERAL; COLUMBIA PICTURES; 2017” and a scene identifier 106 “SCENE 26; ECONOMY SERVICE AREA”. The comparison algorithm has thus detected that the user is watching scene 6 of the film “FERAL” released in 2017 by Columbia Pictures.

The film identifier 105 is provided in three parts: a first part comprising a title; a second part comprising the production company; and a third part comprising the date of release. The second part of the film identifier 105 is used to determine which group of databases to interrogate. In this case, Databases 3-5 which comprises data relating to films of COLUMBIA PICTURES. The first and third parts of the film identifier 105, the title “FERAL” determines which of those databases 3-5 to interrogate, in this case Database 3 (107) and the date of release may also be used to identify the correct database. As shown in FIG. 2B characters 28 and 29 are wearing inter alia a blouse 30, a scarf 31 and a necklace 32.

FIG. 5 shows a screen shot of a user interface 70 of a database 107 used by the film production company, such as that available under the trade name Final Draft, Tagger by A Cast & Crew Company. The user interface 70 comprises a title “FERAL” 71, and incorporating a script window 72 displaying a shooting script 73 for the film. A navigator window 74 displaying inter alia a list of scene numbers 75 associating script page numbers 76, location details 77, time 78 and length of scene 79. Further information about each scene is available through interface 80 including Wardrobe 81 and Props 83 is listed in category list 82. When Wardrobe 81 is selected from category list 82, a wardrobe tag list 84 of wardrobe items used in the selected scene is displayed. When an item 85 is selected from the list, a full “tag” description is revealed, which tag may include a brand, item description and a Stock Keeping Unit (SKU) number or a Universal Product Code (UPC number).

The scene identifier 106 is then used to interrogate the database 107 for “SCENE 26” to obtain full “tag” descriptions of items listed under Wardrobe 81 and Props 83, but may also include other lists, such as hair and make-up to produce a list of items 108 appearing in the scene, as shown in FIG. 3B.

The list of items 108 comprises, in this case, three items: a River Island Blouse; a Burberry Scarf; and a Tiffany Necklace. Each item is listed with an item data packet 109, 110, 111 comprising brand, brief description, a SKU number and a UPC number. A handling routine 113 is executed on runtime server 57, which takes each item data packet 109, 110, 111 and inserts the data into a shopping search engine 112, such as that provided by Kelkoo, Amazon, eBay, Google etc. with a view to obtaining a link to a retailer 114.

At least part of the description held in each item data packet 109, 110, 111, such as the brand and short title, is associated with the link to the retailer 114 found using the shopping search engine 112 and sent to the VUUGLE app on user's smart phone 1 and displayed in a user interface 117 as a list 115 on screen 9 of the user's smartphone 1, as shown in FIG. 6. Also appearing on the user interface 117 are the film title 71 taken from the film identifier 105 and scene title 116 taken from the scene identifier 106.

It is envisaged that if there exists a photo 118, 119, 120 of the item full “tag” descriptions in the database 107, a photo would also be sent to the smartphone 1 along with the brand and short title. Alternatively, the photo 118, 119, 120 may be obtained from the shopping search engine result.

It is envisaged that database may comprise item data about items which are commercially available and some which are not. A filter may be applied on the database to only make available item data of items which are commercially available. If the shopping search engine results does not yield a result with sufficient accuracy, the item may be ignored and not presented on the list displayed on the user interface 117 on the user's smart phone 1.

Optionally, a user information database (not shown) may be compiled from the user's activity using the “VUUGLE” product and service. Such a user database may be compiled in a Structured Query Language (SQL) database. Such information which would be stored in such a database is: data profile, film viewing history and purchasing history and behaviour. The runtime server 57 may run a user data program to record the user's history using the VUUGLE app and store the data in a data file. Sample data is set out below:
Example Profile Data Name: Jamie Jones
Location: Windsor, Berkshire
Status: Single
Job: IT Specialist
Gender: Male Age: 35 Email: Jamie.jones46@hotmail.com
Hobbies: Golf, cycling
Interests: James Bond, John Wick, Tom Cruise, Jason Bourne
Activity Data Film: Casino Royale
Date: 12.12.19 Time: 19:35
Platform: Netflix VOD
Viewing Device: LG Smart TV
Used iPhone X device with Vuugle.tv App
Purchased online 007 sunglasses during viewing the ‘Bahamas Scene 1:45-1:55’
007 Limited edition Sunglasses @ £69.99
Used PayPal for Payment
Shipped to home address 16 Ashview Gardens, Windsor, Berkshire

History Data Currently 4 items in his wish list/board:
♥ White Hugo Boss Shirt from ‘Casino Royale’
♥ Biker Jacket ‘Top Gun’
♥ Omega Divers Watch ‘Skyfall’
♥ Leather Briefcase ‘John Wick’
Recorded app time stamp history:
Casino Royal—Netflix—White Shirt Detected in 1:49 @ Date: 12.12.19 Time: 19:35
Matrix—ITV Catch up—Motorbike in 2:33 @ Date: 12.12.19 Time: 15:38
Masters Golf Sky Sports—Nike Golf Shoes @ Date: 12.12.19 Time: 19:43
Saturday Kitchen—BBC1—Jack Daniels Honey Whiskey @ Date: 12.12.19 Time: 10:45

It is envisaged that the user 15 may be slow to pick up the smart phone 1 and to open the VUUGLE app. Thus it is envisaged that the VUUGLE app will comprise a subroutine to allow the user to scroll back through list of items for other scenes in the film.

It is also envisaged that a user would view content, such as films and music videos, on a smart device 200, typically, an iPad or other tablet. Such a system would not necessarily require a physical step of taking an image of a screen with another device. FIG. 7 shows such a smart device 200. The smart device 200 comprises a screen 201 for viewing pre-recorded content 203, typically the pre-recorded content comprises a plurality of scenes, a number of items shown in each scene, in this case a tie 204, a shirt 205, a belt 206, trousers 207 and shoes 208. The smart device 200 has at least one internal processor (not shown), typically also having an inbuilt Wi-Fi aerial running around the inside of the smart device 200 providing a wireless a connection 202 to internet. The internet provides access to a number of computing devices, such as servers 56 and 57 and a machine learning cloud, such as machine learning cloud 100 shown in FIGS. 3A, 3B and 4. The internet also provides access to at least one database, such as database 107 which has a plurality of scene identifiers, such as scene number and a link to show the relevant part of the script. Each scene identifier is associated with item data describing the actual items 204-208 shown in that scene. The smart device 200 comprises software routine to take a screen shot. The user executes the software routine by pressing on screen VUUGLE button 210. The VUUGLE button 210 appears on the overlaying screen template 211, which also comprises amongst other things, a play/stop button 212, bar 213 with an time indicator 214 to indicate elapsed time of the film content. The system comprises the steps of a user capturing at least one image of the screen by pressing the VUUGLE button 210 to take a screen shot. By pressing the VUGGLE button 210, the software routine optionally takes a screen shot of the film appearing beneath the template 211, so that the template 211 does not appear in the captured image. The at least one image may be processed to obtain at least one prepared image, by compressing the image, enhancing the image or deleting certain information from the image or adding information to the image packet, such as elapsed time of the content. Optionally, the processing step includes an algorithm to delete the screen template 211, if it appears in the image. The prepared image packet is sent to the machine learning cloud, whereupon a comparison algorithm such as algorithm 104 is used to compare the at least one prepared image with a data bank of stock images obtained from a substantial number of stock scenes of pre-recorded stock content, each stock scene assigned with a scene identifier, the machine learning cloud identifying said scene with a degree of certainty, inserting the respective scene identifier in the database 107 to obtain said item data appearing in said scene, sending at least a portion of said item data, such as brand names, short description and a picture or data relating to each item to the user by email or directly to the smart device by text, WhatsApp, or the like or directly to the smart device within the VUUGLE app, with a link to a web page for each item. Such a system is useful in the case of the content, such as a film or music video, is viewed on a smart device, typically and iPad or other tablet. The screen shot optionally executes an algorithm which takes a burst image comprising a plurality of images to be processed and prepared for use in the machine learning cloud comparison step.

1. A system for pointing to a web page, the system comprising a screen for viewing pre-recorded content, the pre-recorded content comprising a plurality of scenes, a number of items shown in each scene, a mobile camera device having a camera, at least one processor, a connection to internet and access to a multiplicity of computing devices in the internet comprising a machine learning cloud and at least one database comprising a plurality of scene identifiers each scene identifier associated with item data describing the items shown in that scene, the system comprising the steps of a user capturing at least one image of the screen displaying the pre-recorded content with said mobile camera device, processing the at least one image to obtain at least one prepared image, sending said at least one prepared image to the machine learning cloud, executing a comparison algorithm to compare said at least one prepared image with a data bank of stock images obtained from a substantial number of stock scenes of pre-recorded stock content, each stock scene assigned with a scene identifier, the machine learning cloud identifying said scene with a degree of certainty, inserting the respective scene identifier in the database to obtain said item data appearing in said scene, sending at least a portion of said item data or data relating thereto to said user, with a link to said web page for each item.

2. A system for pointing to a web page, the system comprising a screen for viewing pre-recorded content, the pre-recorded content showing a number of items, a mobile camera device having a camera, at least one processor, a connection to internet and access to a multiplicity of computing devices in the internet comprising a machine learning cloud and at least one database comprising a content identifier associated with item data describing the items shown in the pre-recorded content, the system comprising the steps of a user capturing at least one image of the screen displaying the pre-recorded content with said mobile camera device, processing the at least one image to obtain at least one prepared image, sending said at least one prepared image to a machine learning cloud, executing a comparison algorithm to compare said at least one prepared image with a data bank of stock images obtained from a substantial number of pre-recorded stock content, each pre-recorded stock content assigned with an identifier, the machine learning cloud identifying said pre-recorded content with a degree of certainty, inserting the respective identifier into the database to obtain the item data, sending at least a portion of the item data to said user with a link to said web page for each item.

3. A system of claim 1, wherein at least one of the pre-recorded stock content comprises a plurality of scenes, each scene provided with a scene identifier, the machine learning cloud identifying said scene with a degree of certainty, inserting the respective scene identifier in said database to obtain a list of said items, optionally sending said list of items to said user optionally with a link for each item to said web page.

4. The system of claim 1, wherein the mobile camera device is one of: a smart phone; a tablet; a smart watch; and smart spectacles.

5. The system of claim 1, wherein said item data comprises a brief description of each item, said brief description of each item inserted into a search engine to find the link to said web page.

6. The system of claim 1, wherein the screen forms part of a smart television, laptop, desktop, tablet or other smart phone.

7. The system of claim 1, wherein the mobile camera device comprises a flash, the system comprises software to disable the flash.

8. The system of claim 1, wherein the at least one image is processed to change a colour contrast and optionally, hue.

9. The system of claim 3, wherein the mobile camera device comprises a viewing screen and wherein the list of items is sent to the mobile camera device and displayed on a viewing screen in a user interface.

10. The system of claim 3, wherein the list of items is sent to an email address of the user.

11. The system of claim 1, wherein a characteristic of the screen displaying the pre-recorded content is an oblong: four corners with two pairs of parallel sides, the system comprising a routine to deleted or marked as such from the image as part of the processing and is not used in the step of comparison in the machine learning cloud.

12. The system of claim 1, wherein the mobile camera device comprises a viewing screen, the system further comprising the step of capturing the image comprising a user interface shown on the viewing screen, the user interface comprising a viewing template and a real-time view of a field of view of the camera, optionally the user is prompted to line up a frame of the screen with the template.

13. The system of claim 1, wherein the at least one image is a plurality of images taken as an image burst.

14. The system of claim 1, further comprising the step of prompting the user to take a still image in landscape mode.

15. The system of claim 1, further comprising a computer program or sub routine to automatically capture a still image or image burst upon recognising that the screen is within a predefined field of view and in focus.

16. (canceled)

17. A system for pointing to a web page, the system comprising a smart device comprising a screen for viewing pre-recorded content, the pre-recorded content comprising a plurality of scenes, a number of items shown in each scene, at least one processor, a connection to internet and access to a multiplicity of computing devices in the internet comprising a machine learning cloud and at least one database comprising a plurality of scene identifiers each scene identifier associated with item data describing the items shown in that scene, the smart device comprising software to take a screen shot, the system comprising the steps of a user capturing at least one image of the screen displaying the pre-recorded content with said screen shot, processing the at least one image to obtain at least one prepared image, sending said at least one prepared image to the machine learning cloud, executing a comparison algorithm to compare said at least one prepared image with a data bank of stock images obtained from a substantial number of stock scenes of pre-recorded stock content, each stock scene assigned with a scene identifier, the machine learning cloud identifying said scene with a degree of certainty, inserting the respective scene identifier in the database to obtain said item data appearing in said scene, sending at least a portion of said item data or data relating thereto to said user, with a link to said web page for each item.

18. The system as claimed in claim 17, wherein the smart device is one of: a smart television with screen shot capability; tablet; and smart phone.

19. The system as claimed in claim 17, wherein said screen shot takes an image burst.

20. The system of claim 17, wherein the at least one image is processed to change a colour contrast or change hue.

21. (canceled)

22. The system of claim 17, wherein said comparison algorithm to compare said at least one prepared image with said data bank of stock images obtained from said substantial number of pre-recorded stock content, is trained using stock images obtained from said substantial number of pre-recorded stock using a frame rate of between 5 and 30 frames per second.

23-25. (canceled)
